(19) United States
(12) Patent Application Publication
(10) Pub. No.: US 2005/0232740 A1
(43) Pub. Date: Oct. 20, 2005

(54) Material handling apparatus

(76) Inventor: Paul Cummings, Bicester (GB)

Correspondence Address: PAUL E. MILLIKEN, 9061 WALL STREET, NW, MASSILLON, OH, 44646-1676, US

(21) Appl. No.: 11/154,312

(22) Filed: Jun. 16, 2005

(30) Foreign Application Priority Data
Jan. 11, 2003 (GB) GB 0300651.7

(51) Int. Cl. B66F 9/00

(52) U.S. Cl. 414/680

(57) ABSTRACT

A material handling apparatus (30) to be used in combination with an aerial lift (10) having a work platform (12) surrounded by a safety barrier (17), comprises a jack (32) secured on the platform (12), the jack having a ram (34) with a hoist (31) mounted, preferably rotatably mounted, on the upper end of the ram. The hoist (31) has an upright first arm (45) attached to the ram, a second arm (48) pivoted to the first arm (45), actuator means (53) operable between the first and second arms, and a winch (55) with its cable (67) suspended from the end of the second arm.

### FIELD OF THE INVENTION

This invention relates to material handling apparatus and in particular to apparatus used for lifting or supporting building materials such as guttering.

### BACKGROUND OF THE INVENTION

Building construction sites for large buildings frequently employ construction equipment for lifting large and heavy components into position for fixing onto a building. For example, lengths of standard guttering are typically made from galvanized steel and may be 3 meters in length and weigh in the order of 150 kgs. During construction of a large building the gutters are fixed into position before the roof is completed. The gutters may be laid across the roof joists by use of a crane or other device and then manually manoeuvred into position.

Frequently, aerial lifts are employed for fixing building components at positions high above ground level. A typical aerial lift is a mobile scissor lift available from JLG Ind. and which has a work platform which may be lifted into the air by a hydraulically operable scissor mechanism. For safety the work platform is surrounded by a safety barrier or fence.

These lifts may be provided with auxiliary material handing equipment which is secured to the platform for manoeuvring building materials into location onto a building. An example of such equipment is described in the applicants co-pending GB patent application 0214834.4

The present invention is concerned with auxiliary material handling equipment for lifting and locating guttering onto the roof or eaves of a building.

### STATEMENT OF THE INVENTION

According to the present invention there is provided a material handling apparatus to be used in combination with an aerial lift having a work platform surrounded by a safety barrier, the apparatus comprising a jack having a body which in use rests on the platform and coupling means for securing the body to said barrier, and a ram reciprocable within the body, with a hoist attached to the ram and which has a substantially vertical first arm connected to the ram with a second arm pivoted thereto, an actuator means operable between the first and second arms, and a winch with its cable suspended from the end of the second arm.

The actuator means is preferably hydraulic.

Preferably the hoist is rotatably mounted on the ram, and more preferably the ram has adaptor means on its upper end for securing the hoist thereto.

The jack may be operated by any suitable means, for example the ram may be displaced by mechanical means such as a pawl and ratchet mechanism, or screw threaded drive means, and is preferably a hydraulic jack being operable through a hydraulic control means.

The winch may be operated by any suitable means, for example electric motors, and is preferably operated through a hydraulic motor. Preferably, the winch is mounted on an upper portion of the first arm.

The second arm preferably comprises two telescopic struts the outer strut being pivoted to the first arm, with a pulley for the winch cable being mounted on the end of the inner strut. A second actuator, preferably hydraulic, is operable between the two struts so that the winch is displaceable relative the outer strut.

The apparatus includes a hydraulic control means to which the hydraulic actuators, hydraulically operated winch and hydraulic jack are connected and which includes electrical controls having a control panel for independent or simultaneous operation.

At least one vacuum pad is attached to the free end of the winch cable and is operable to grip onto a surface of the object to be raised.

Each vacuum pad has a closed cell foam seal which in use seals against the object.

The apparatus is particularly adapted for the handing of guttering.

The invention also provides an aerial lift having a work platform surrounded by a safety barrier, and material handing apparatus according to the present invention. The aerial lift is preferably a mobile self drive lift having a platform which is raised by a powered hydraulic system, wherein said hydraulic control means are connected into the powered hydraulic system of the lift.

### DESCRIPTION OF THE DRAWINGS

The invention will be described by way of example and with reference to the accompanying drawings in which:—

FIG. 1 is a side elevation of an aerial lift in a lowered condition and provided with material handling apparatus according to the present invention,

FIG. 2 is a side view of the material handling apparatus of the present invention shown in an elevated condition in use,

FIG. 3 is a side elevation of the hoist shown in a raised and lowered conditions,

FIG. 4 is a side elevation of the jack shown in FIG. 2

### DETAILED DESCRIPTION OF THE INVENTION

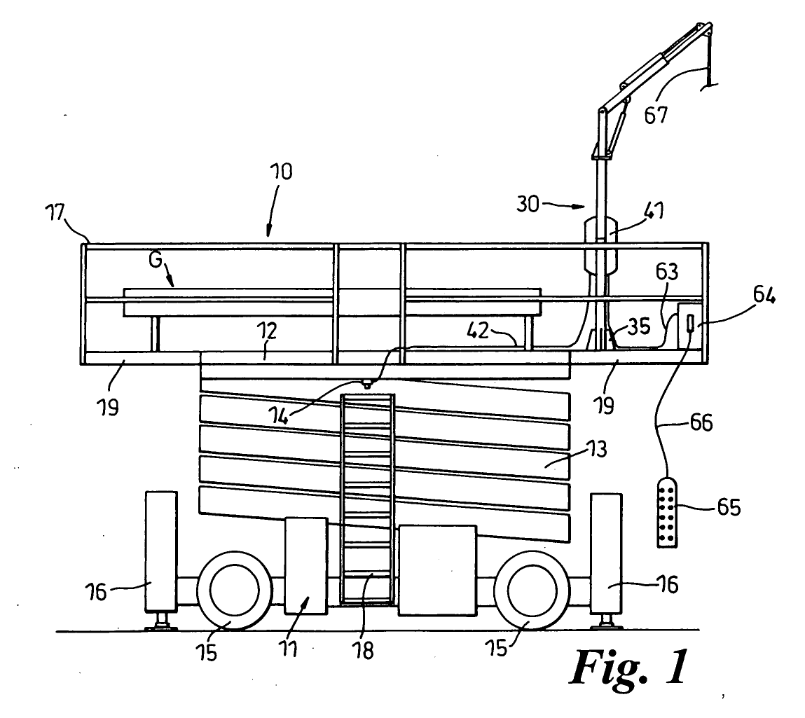

With reference to FIG. 1 of the drawings, there is shown an aerial lift 10 in the form of a self drive mobile scissor lift available from JLG Ind. The lift 10 has a drivable vehicle body 11 having wheels 15 and a work platform 12 located on its body and which in use can be raised or lowered relative to the ground. The platform 12 is shown in a lowered condition and the vehicle body is provided with stabilisers 16 at its corners which are lowered to provide stability during use of the lift. The work platform 12 is raised or lowered by a scissor type mechanism 13 typically operated by a powered hydraulic system provided on the lift. The hydraulic system is provided with a manifold 14 whereby hydraulic power may be taken from the powered system of the lift and used to operate material handling apparatus 30 of the present invention. The platform 12 has extendable end portions 19 and the whole platform is provided with a safety barrier 17 formed from rails and an access ladder 18 is provided on the body 11 for access to the platform 12 when in the lowered condition. The aerial lift 10 is provided with an auxiliary material handling apparatus 30 located at any desired position on the platform, and preferably on one of the extendable end portions thereof and which is shown in FIG. 1 in a raised condition.

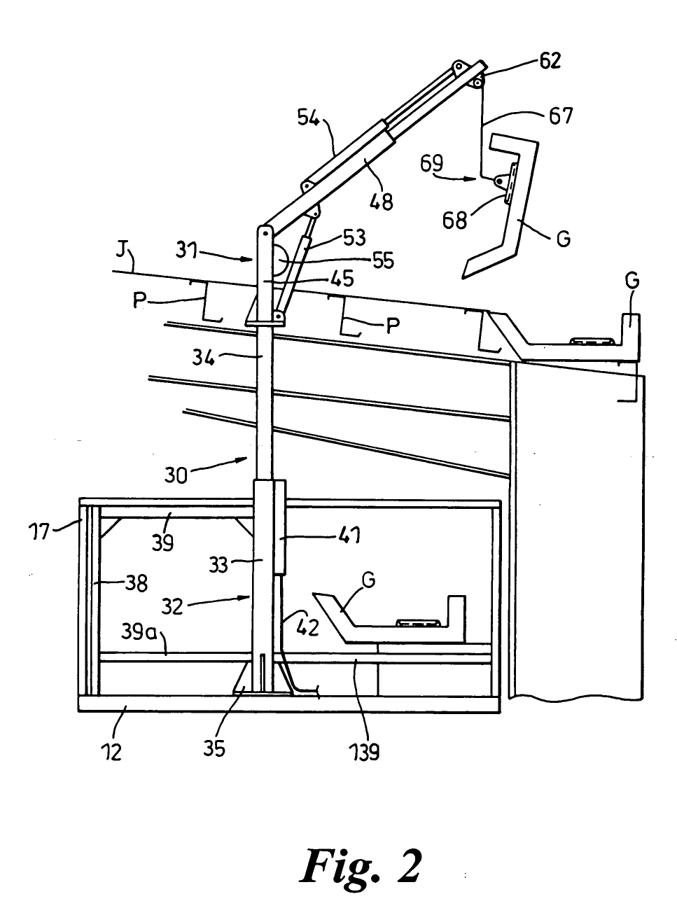

Referring additionally to FIGS. 2 to 4, the material handling apparatus 30 comprises a jack 32 and a hoist 31. The jack 32 is substantially vertical and comprises a jack body 33 having a reciprocable ram 34 telescopically mounted within the body 33. The ram 34 and body 33 have substantially square cross-sections. The jack body 33 has a foot 35 that rests on the platform 12 and the head of the ram 34 is provided with an adaptor plate 36 to which the hoist 31 is attached. A hydraulic actuator 37 acts between the jack body 33 and the ram 34 and is operable to move the ram into and out of the body.

The jack 32 is located on one extendable end portion 19 of the platform 12 and is secured to the inside of the barrier rail 17. A substantially vertical support leg 38, spaced from the jack 22, is secured to the inside of the barrier rail 17 and a pair of spaced apart substantially horizontal struts 39 & 39A extend between the jack body 33 and leg 38 to hold the jack in position. A further horizontal strut 139 extends oppositely to the lower strut 39A to secure the jack body 33 to the opposite side of the barrier rail 17.

The hydraulic jack 32 is operated through a hydraulic control means 41 which is fixed on one side of the jack body 33. The hydraulic control means 41 is connected by flexible hydraulic hose 42 to the manifold 14 for take-off of hydraulic power from the lift hydraulic system.

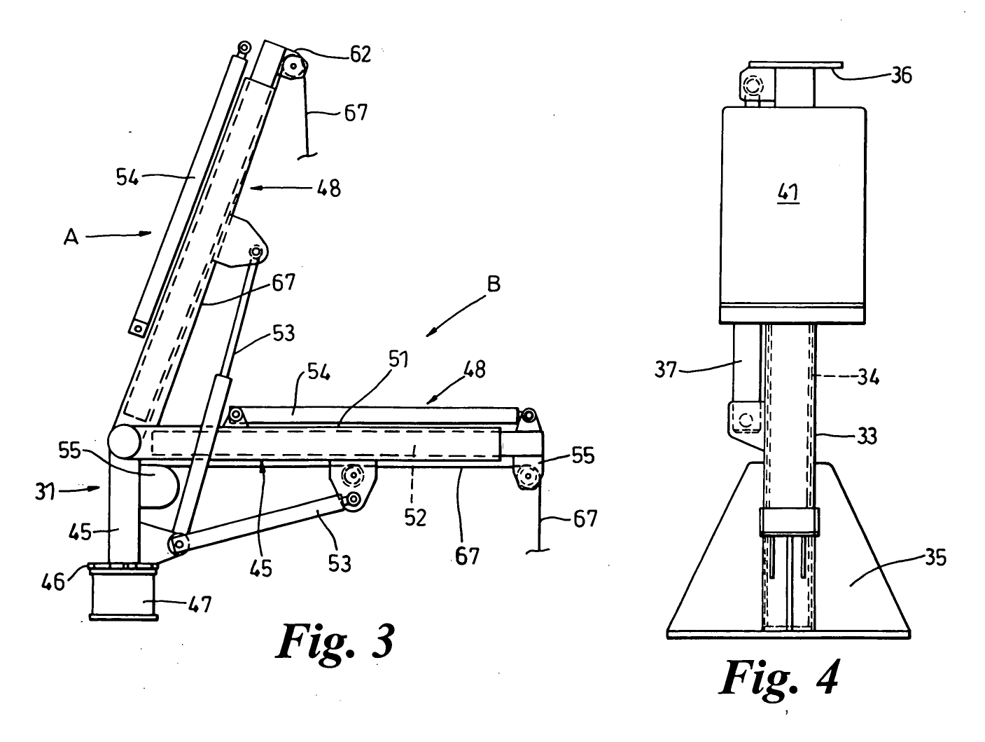

With reference in particular to FIG. 3, the hoist 31 is shown in two conditions, a raised condition A and a lowered condition B. The hoist 31 comprises a substantially upright arm 45 which is mounted to a base plate 46. The base plate 46 may be secured directly to the adaptor plate. 36 on the ram 34, as shown in FIG. 2 in which case the hoist 31 is fast with the jack 32. Alternatively, the base plate 46 is secured to a thrust bearing 47 as shown in FIG. 3 which is in turn secured to the adaptor plate 36 so that the hoist 31 is rotatably mounted to the jack 32.

A second arm 48 is pivoted to upper end of the upright arm 45 for movement about a horizontal axis. The second arm 48 comprises an outer strut 51 which is mounted to the upright arm 45 and an inner strut 52 telescopically slidably mounted within the outer strut 51 for reciprocating movement within the outer strut. A hydraulic actuator 53 acts between the upright arm 45 and the outer strut 51 of the second arm for raising and lowering the second arm 48 relative to the upright arm 45, and another hydraulic actuator 54 acts between the outer and inner struts 51, 52, respectively for extension and contraction of the second arm 48.

The hoist 31 further includes a winch 55 located on the upper end portion of the upright arm 45 and is operated by a hydraulic motor. The hydraulically operated winch 55 and actuators 53 & 54 are connected via flexible hydraulic hoses to the hydraulic control means 41. The control means 41 is connected by electrical cable 63 to a control panel 64 which controls the operation of the hydraulic control means 41. The control panel may also be operated through a remote pendulum set 65 which is connected to the panel 64 through electrical cable 66.

The winch 55 has a cable 67 (see also FIG. 2) as is well known and which passes along the length of the second arm 48 and around a pulley 62 mounted on the end of the inner strut 52. The winch 55, when utilised for the handling of materials, especially guttering G, has the free end of the hoist cable 67 attached to a head 69 having at least one and preferably two vacuum suckers or pads 68 mounted thereon. Each vacuum pad 68 has a closed cell foam seal which enables the pad to grip on relatively rough surfaces. The vacuum suckers 68 are connected by flexible vacuum pipe to a vacuum pump (not shown) located on the platform 12. The vacuum pump is driven by power sources on the body 11 of the lift. The suckers 68 may each have a grip in the order of 2000 kg. A vacuum sensor may be included in the vacuum line to sense when a respective pad 68 is gripping against a surface and each sucker may be provided with a non-return valve which ensures that the vacuum remains in operation in the event of a failure at the vacuum source.

The hydraulic jack 22, and actuators 53,54 can be individually or jointly operated from the control panel 64 or pendulum set 65. The hydraulic winch 55 can also be likewise controlled from the panel 64 and pendulum set 65. The control system may be arranged so that the jack 22, actuators 53,54 and winch 55 are operable only when the scissor lift is in a static condition.

In use, the material handling apparatus 30 is utilised for lifting over small height range for example from the lift platform 12 onto a structure immediately above the platform as shown in FIG. 2.

Lengths of guttering G are stored on platform 12 to one side of the material handling apparatus 30 which may be lifted on the aerial platform 12 until it projects through joists J and purlins P of the open roof. The jack 32 and hoist 31 provide a means of picking up, lifting and manoeuvring the lengths of guttering G, from the platform 12 and into location on the roof whilst the guttering is at all times under control and held by the apparatus.

1. A material handling apparatus to be used in combination with an aerial lift having a work platform surrounded by a safety barrier, the apparatus comprising a jack having a body which in use rests on the platform and coupling means for securing the body to said barrier, and a ram reciprocable within the body, with a hoist attached to the ram and having a substantially vertical first arm connected to the ram with a second arm pivoted to the first arm, actuator means operable between the first and second arms, and a winch with its cable suspended from the end of the second arm.

2. Apparatus as claimed in claim 1, wherein the hoist is rotatably mounted on the ram.

3. Apparatus as claimed in claim 2, wherein the ram has an adaptor plate on its outer end for securing the hoist thereto.

4. Apparatus as claimed in claim 1, wherein the jack is a hydraulically operated jack.

5. Apparatus as claimed in claim 1, wherein
the winch is operated through a hydraulic motor.

6. Apparatus as claimed in claim 1, wherein the second arm comprises two telescopic struts, the outer of said struts being pivoted to the first arm, with a cable pulley being mounted on the inner of said struts so that the pulley is displaceable relative the outer strut.

7. Apparatus as claimed in claim 1 wherein the actuator means operable between said first and second arms is a hydraulic actuator.

8. Apparatus as claimed in claim 6, wherein a second hydraulic actuator is operable between the two struts.

9. Apparatus as claimed in claim 1, wherein the winch is mounted on the upper end portion of the upright first arm.

10. Apparatus as claimed in claim 1 and further including at least one vacuum pad which is attached to the free end of the winch cable and is operable to grip onto a surface of the object to be raised.

11. Apparatus as claimed in claim 10, wherein the or each vacuum pad has a closed cell foam seal which in use seals against the object.

12. Apparatus as claimed in claim 1, wherein the second arm comprises two telescopic struts, the outer of said struts being pivoted to the first arm, with a cable pulley being mounted on the inner of said struts so that the pulley is displaceable relative the outer strut, the actuator means operable between said first and second arms is a hydraulic actuator, and a second hydraulic actuator is operable between the inner and outer struts, the jack is a hydraulically operated jack, the winch is operated through a hydraulic motor, the apparatus further including a hydraulic control means to which the hydraulic actuators, hydraulic winch and hydraulic jack are connected and which includes electrical controls having a control panel for independent or simultaneous operation.

13. An aerial lift having a work platform surrounded by a safety barrier, and material handing apparatus according claim 1.

14. An aerial lift having a work platform surrounded by a safety barrier, wherein the aerial lift is a mobile self drive lift having a platform which is raised by a powered hydraulic system, and a material handling apparatus as claimed in claim 12, wherein said hydraulic control means are connected into said powered hydraulic system.

15. A lift as claimed in claim 13 wherein the platform has at least one extendable end portion, and the material handling apparatus is located on said extendable end portion.
